(19) United States
(12) Patent Application Publication
(10) Pub. No.: US 2023/0356236 A1
(43) Pub. Date: Nov. 9, 2023

(54) MILLING SYSTEM FOR EDIBLE MATERIAL

(71) Applicant: McCormick & Company, Inc., Hunt Valley, MD (US)

(72) Inventors: Stephen LOMBARDO, Baltimore, MD (US); Denise FARMER, Parkville, MD (US); William CONWAY, Baltimore, MD (US); Kian Min LIM, Cambridge (GB); Ian DUNCKLEY, Cambridge (GB); Richard CLARIDGE, Hertfordshire (GB); David RUSSELL, Hertfordshire (GB)

(73) Assignee: McCormick & Company, Inc., Hunt Valley, MD (US)

(21) Appl. No.: 17/735,790

(22) Filed: May 3, 2022

(51) Int. Cl. B02C 25/00; B02C 4/32; B02C 4/02; B02C 4/42

(52) U.S. Cl. CPC B02C 25/00; B02C 4/32; B02C 4/02; B02C 4/42

(57) ABSTRACT

A milling system for milling an edible input material into an edible product configuration meeting a product specification includes a plurality of mills arranged in parallel and connected by recycle loops. A measurement system is provided for measuring attributes of the mills and attributes of the edible input material upstream and downstream of the mills. A continuously self-learning control system is provided for performing operations based on a continuously self-learning algorithm. The operations include processing measurement data of the measurement system to control the mills while maximizing particle sizes in the system, and receiving an operator selection identifying the edible input material to be milled and the edible product configuration to be produced by the milling system. The control system initializes and operates the mills based on an initial control model of the milling system associated with the selection, and continuously updates the control model and mill settings.

### BACKGROUND

### 1. Field

The present disclosure relates to milling, and more specifically to milling methods and systems for edible materials, such as spices, herbs, seeds, or combinations thereof.

### 2. Description of Related Art

Spices are milled from a raw material into a product configuration meeting product specifications, such as particle size, moisture content, and bulk density. Each product configuration may be a distinct shop keeping unit (SKU), such as “coarse black pepper” and “fine ground pepper.” For spice milling, it is often not desirable to grind every raw material into the finest particle size possible. Instead, it is often desirable to grind the raw material so that the material has a particle size specifically matching the product specifications of the desired product configuration.

Some spice milling systems use milling equipment designed for flour milling Typically, flour milling is performed as a serial process of moving grain through a series of mills, each having a set of milling rollers spaced apart by a gap. The gap of successive mills decreases in size in the direction of material flow in order to successively reduce the particle size of the grain. Most flour mills are arranged in series so that all of the grain passes through every mill in sequence one time. The serial flow through the mills reduces the particle size of the grain to a very fine powder, which is the objective of flour milling.

In some spice mills, each mill is manually operated by an operator who can adjust various parameters of the mill based on the operator's own skill and prior knowledge. Moreover, many mills are independently operated so that the adjustments made to one mill are not visible to other parts of the milling system and do not trigger adjustments to any other part of the milling system. In addition, some milling systems measure particle sizes at discrete times and locations, such as close to the end of the milling process, which makes it more difficult for operators throughout the milling process to make adjustments and to observe how those adjustments impact the process.

Because each mill is independently and manually operated, large variations in particle sizes can develop between the mills and in the finished product at the end of the milling process. As noted above, since particle size is one of the main parameters of a finished product configuration for spices, a large variation in particle size at the end of the milling process results in some of the milled material having particle sizes that do not meet the product requirements of the product configuration. Such material must be sorted, separated, and removed from the process. The removed material represents a waste or inefficiency in the milling process.

### SUMMARY

One aspect of the present disclosure to reduce the aforementioned waste or inefficiency is a milling system for milling an edible input material, which includes a spice, an herb, a seed, or a combination thereof, into an edible product configuration meeting a target output specification. The system includes a first mill including a first set of milling rollers configured to mill the edible input material into particles having sizes defining a first particle size distribution. The particle size distribution includes a first range of particle sizes and a second range of particle sizes different from the first range of particle sizes.

Also, the milling system includes a second mill including a second set of milling rollers configured to mill particles of the edible input material having particle sizes only in the second range of particle sizes.

In addition, the system includes a measurement system configured to generate measurement data. The measurement system includes at least one inline sensor configured to measure attributes of the edible input material upstream and downstream of the first and second mills. The attributes of the edible input material include at least one of particle size, moisture bulk density, and flow rate. Also, the measurement system includes at least one sensor to measure attributes of the first and second sets of milling rollers.

Also, the milling system includes a continuously self-learning control system, including a processor and a memory. The processor is configured to perform operations based on a continuously self-learning algorithm. The operations include receiving and processing the measurement data to dynamically control in real-time the first and second sets of milling rollers to mill the edible input material into the edible product configuration while maximizing a first ratio of particle size upstream of the first mill to particle size downstream of the first mill, and maximizing a second ratio of particle size upstream of the second mill to particle size downstream of the second mill.

By maximizing the first and second ratios, the amount of particles having a particle size that is too small (below the particle size specified by the target output specification) edible product configuration) can be minimized to reduce waste and increase system efficiency. Also, by maximizing the first and second ratios, particles exiting the mills that are too large (above the particle size specified by the target output specification) edible product configuration) can be sorted and returned to the first and/or second mills to reduce their size until they fall within product specifications. Thus, the system in accordance with the present disclosure is configured to minimize fines and reduce waste.

Also, the afore-mentioned operations include receiving a selection (e.g., an operator selection made using a human machine interface) identifying the edible input material to be milled and the edible product configuration to be output by the milling system. In response to receiving the selection, the control system is configured to initialize operational settings of the first and second sets of milling rollers based on an initial control model of the milling system associated with the selection and operate and control the first and second mills to mill the edible input material based on the initial operational settings, and continuously update the control model and operational settings based on at least the continuously self-learning algorithm, the measurement data, and the target output specification.

In embodiments, the control system is configured to store a control model corresponding to the edible product configuration and the edible input material. The control system is configured to determine whether a control model is stored corresponding to the selection of the edible input material and the edible product configuration. If the control system determines that a control model is stored corresponding to the selection of the edible input material and the edible product configuration, the control system is configured to retrieve the stored control model as the initial control model. If the control system determines that a control model is not stored corresponding to the selection of the edible input material and the edible product configuration, the control system is configured to operate the milling system in a learning mode to generate the initial control model.

In the learning mode the milling system is operated and controlled to generate measurement data while producing a plurality of samples of milled edible input material, and the control system is configured to process the measurement data associated with producing the plurality of samples to generate the initial control model.

Thus, the mills of the system constructed in accordance with the first aspect are automatically controlled and adjusted by a self-learning control system that globally monitors the inputs and outputs of the mills and other parts of the milling system and makes adjustments to individual parts of the system based on a predictive model to obtain the desired edible product configuration meeting the target output specification. Moreover, the model is obtained by a learning algorithm that can be updated repeatedly during operation of the milling system. The model is based on the type of input material (e.g., black pepper berries) and a selected edible product configuration (e.g., product shop keeping unit “coarse black pepper”).

In embodiments, the at least one sensor to measure attributes of the first and second milling rollers is configured to measure at least one of a gap and a speed ratio between milling rollers of the first and second sets of milling rollers, and the control system, in response to the measurement data, is configured to adjust at least one of the gap and speed ratio between milling rollers of the first and second sets of milling rollers. The milling rollers of the first mill are configured to be adjusted independently of the milling rollers of the second mill.

In embodiments, the milling system includes a distribution system configured to collect, sort, and distribute particles of edible input material between the first and second mills and a finished product storage based on the measurement data. The distribution system includes a sorter configured to sort particles by particle size and a blower configured to distribute particles to the first and second mills and the finished product storage by particle size.

In embodiments, the control system is configured to adjust at least one of the first and second mills in response to a comparison of attributes of particles of edible input material entering the finished product storage and the target output specification. In a first configuration where a difference in attributes between the edible input material entering the finished product storage and the target output specification are greater than a threshold, the control system is configured to adjust at least one operational setting of at least one of the first and second mills based on the control model. In a second configuration where the difference in attributes between edible input material entering the finished product storage and the target output specification are less than the threshold, the control system is configured to maintain the operational settings of the first and second mills.

In embodiments, the measurement system includes an inline bulk density measurement device that is configured to receive and measure bulk density of samples of edible input material upstream and downstream of the first and second mills and upstream of the finished product storage.

In embodiments, the second range of particle sizes includes particle sizes larger than particle sizes in the first range of particle sizes.

In embodiments, the milling system further includes a third mill configured to mill particles of edible input material. The second mill is configured to mill particles of edible input material into particles having sizes defining a second particle size distribution. The second particle size distribution includes particle sizes in the first range of particle sizes and a third range of particle sizes different from the first range of particle sizes. The second mill is configured to mill particles having particle sizes in a first sub-range of the third range of particle sizes and the third mill is configured to mill particles having particle sizes in a second sub-range of the third range of particle sizes different from the first sub-range.

According to another aspect of the disclosure, a milling method for a milling system adapted for milling an edible input material is described. The method includes a first milling by a first mill of the milling system. The first mill includes a first set of milling rollers for milling the edible input material into particles having sizes defining a first particle size distribution. The particle size distribution includes a first range of particle sizes and a second range of particle sizes different from the first range of particle sizes. The method also includes a second milling by a second mill of the milling system. The second mill includes a second set of milling rollers for milling particles of the edible input material having particle sizes only in the second range of particle sizes.

The method also includes generating measurement data by inline measuring attributes of the edible input material upstream and downstream of the first and second mills. The attributes of the edible input material include at least one of particle size, moisture bulk density, and flow rate. Generating measurement data also includes measuring attributes of the first and second sets of milling rollers.

Further, the method includes controlling the milling system, by a continuously self-learning control system based on a continuously self-learning algorithm, by performing operations including receiving and processing the measurement data to dynamically control in real-time the first and second sets of milling rollers to mill the edible input material into the edible product configuration, while maximizing a first ratio of particle size upstream of the first mill to particle size downstream of the first mill and maximizing a second ratio of particle size upstream of the second mill to particle size downstream of the second mill. Also, the operations include receiving a selection identifying the edible input material to be milled and the edible product configuration to be output by the milling system. The edible product configuration is associated with the target output specification.

In response to receiving the selection, the controlling includes initializing operational settings of the first and second sets of milling rollers based on an initial control model of the milling system associated with the selection and operating and controlling the first and second mills to mill the edible input material based on the initial operational settings, and continuously updating the control model and operational settings based on at least the continuously self-learning algorithm, the measurement data, and the target output specification.

In embodiments, the milling method further includes determining whether a control model is stored corresponding to the selection of the edible input material and the edible product configuration. If it is determined that a control model is stored corresponding to the selection of the edible input material and the edible product configuration, the method includes retrieving the stored control model as the initial control model. If it is determined that a control model is not stored corresponding to the selection of the edible input material and the edible product configuration, the method includes operating the milling system in a learning mode to generate the initial control model.

In the learning mode, the milling system is operated and controlled to generate measurement data while producing a plurality of samples of milled edible input material. The controlling includes processing the measurement data associated with producing the plurality of samples to generate the initial control model.

In embodiments, the attributes of the first and second milling rollers include at least one of a gap and a speed ratio between milling rollers of the first and second sets of milling rollers, and the controlling includes, in response to the measurement data, adjusting at least one of the gap and speed ratio between the rollers of the first and second sets of milling rollers, wherein the milling rollers of the first mill are adjusted independently of the milling rollers of the second mill.

In embodiments, the milling method further includes collecting the milled particles of the edible input material, sorting the collected particles of the edible input material by particle size, and distributing the sorted particles of the edible input material by particle size between the first and second mills and a finished product storage.

In embodiments, the controlling includes adjusting at least one of the first and second mills in response to a comparison of attributes of particles of edible input material entering the finished product storage and the target output specification. When a difference in attributes between the edible input material entering the finished product storage and the target output specification are greater than a threshold, controlling includes adjusting at least one operational setting of at least one of the first and second mills based on the control model. When the difference in attributes between edible input material entering the finished product storage and the target output specification are less than the threshold, controlling includes maintaining the operational settings of the first and second mills.

In embodiments, the generating measurement data includes measuring bulk density of edible input material sampled upstream and downstream of the first and second mills and upstream of the finished product storage.

In embodiments, the second range of particle sizes includes particle sizes larger than particle sizes in the first range of particle sizes.

In embodiments, the milling system further includes a third milling by a third mill having a third set of milling rollers configured to mill particles of edible input material. The second milling mills particles of edible input material into particles having sizes defining a second particle size distribution, the second particle size distribution including particle sizes in the first range of particle sizes and a third range of particle sizes different from the first range of particle sizes. The second milling mills particles having particle sizes in a first sub-range of the third range of particle sizes and the third milling mills particles having particle sizes in a second sub-range of the third range of particle sizes different from the first sub-range.

According to yet another aspect of the disclosure, a control method for continuous self-learning and control of a milling system having a plurality of mills coupled together by a particle distribution system is provided. The mills are configured to mill an edible input material in parallel based at least on particle size into an edible product configuration having an associated target output specification. The control method includes learning an initial control model of the milling system based at least on measured attributes of the edible input material sampled at a plurality of locations in the milling system. The method also includes continuously self-learning and updating the initial control model with an optimized control model, storing the updated control model, and controlling and regulating the plurality of mills during the learning and updating of the initial control model. The initial and updated control models of the milling system are used for controlling and regulating the milling system to mill the edible input material into the edible product configuration while maximizing a ratio of particle size of edible input material upstream of each mill to particle size of edible input material downstream of each mill.

In embodiments, the learning includes initializing operational parameters of the plurality of mills of the milling system, controlling and regulating the mills to produce a plurality of samples of milled edible input material while obtaining measured attributes of the edible input material, and generating the initial control model that relates operational parameters of the milling system and the measured attributes of the edible input material to the target output specification.

In embodiments, the learning includes predicting updated operational parameters of the plurality of mills from a comparison of measured attributes of the milled edible input material and the target output specification, and updating the operational parameters of the mills with the predicted updated operational parameters. The operational parameters are limited by a predetermined range of operational limits.

In embodiments, the method includes retrieving a stored control model in response to receiving a selection of an edible input material and an edible target product associated with the stored control model; and configuring the milling system in accordance with operational parameters associated with the retrieved control model.

### BRIEF DESCRIPTION OF THE DRAWINGS

The present disclosure is further described in the detailed description which follows, in reference to the noted plurality of drawings by way of non-limiting examples of exemplary embodiments of the present disclosure, in which like reference numerals represent similar parts throughout the several views of the drawings.

FIG. 1 is a schematic of a milling system in accordance with an aspect of the disclosure.

FIG. 2 shows a partial view of the milling system shown in FIG. 1.

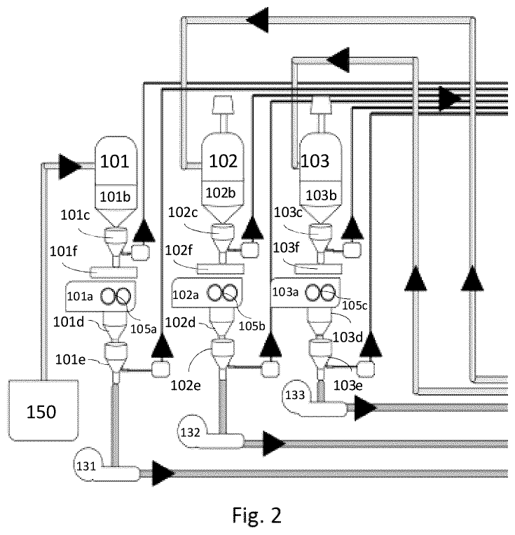

FIG. 3 is a schematic of a control architecture in accordance with an aspect of the disclosure.

FIG. 4 shows further details of the control architecture shown in FIG. 3

FIG. 5 illustrates modes of operation of the milling system in accordance with an aspect of the disclosure.

FIG. 6 illustrates a logic workflow of a learning algorithm used when the milling system is operated in a learning mode in accordance with an aspect of the disclosure.

FIG. 7 illustrates a logic workflow of a control algorithm used when the milling system is operated in a control mode in accordance with an aspect of the disclosure.

FIG. 8 illustrates a workflow for operating the milling system in accordance with an aspect of the disclosure.

### DETAILED DESCRIPTION

The particulars shown herein are by way of example and for purposes of illustrative discussion of exemplary embodiments of aspects of the present disclosure only and are presented in the cause of providing what is believed to be the most useful and readily understood description of the principles and conceptual aspects of the present disclosure. In this regard, no attempt is made to show structural details in more detail than is necessary for the fundamental understanding of the aspects of the present disclosure, the description taken with the drawings making apparent to those skilled in the art how the forms of the aspects of the present disclosure may be embodied in practice.

Hereafter, embodiments of the present disclosure are described with reference to the drawings. In this detailed description, unless indicated otherwise, “upstream” means in a direction towards the start of the milling process described herein and word “downstream” means in a direction towards the end of the milling process described herein.

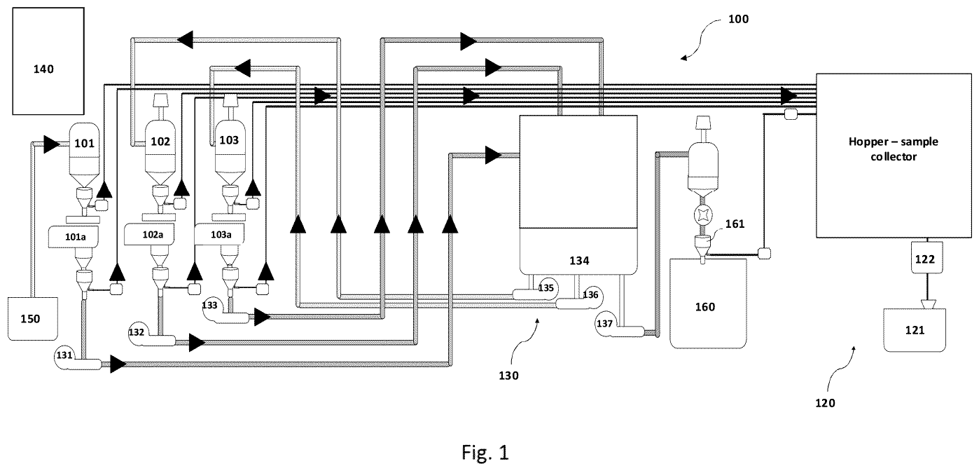

FIG. 1 is a schematic of a milling system 100 in accordance with a first aspect of the disclosure. The milling system 100 is configured for milling an edible input material into an edible product configuration meeting a target output specification. The edible product configuration can be a name of a finished product or product identifier. The target output specification includes one or more required characteristics of the edible product configuration, such as particle size and bulk density, and moisture content. The edible input material includes a spice, an herb, a seed, or a combination thereof. For ease of discussion, and not by way of limitation, the milling system 100 shown in FIG. 1 will be described with reference to milling spice berries (as the edible input material), such as pepper berries, into an edible product configuration, such as ground pepper. Of course, from the foregoing description, it is to be understood that other spices, herbs, and/or seeds may be milled by the system of FIG. 1 and that discussion of pepper berries are by way of example only and not limitation.

The milling system 100 generally includes a plurality of breaks (three are shown, 101, 102, and 103) for milling the edible raw material, a measurement system 120 for measuring parameters throughout the system 100, a distribution system 130 for handling material flow through the system, and a control system 140 for controlling the breaks 101, 102, 103, measurement system 120, and the distribution system 140.

The milling system 100 is connected to a supply of edible input material 150, such as a hopper filled with whole spice berries. As noted above, the milling system 100 includes a plurality of breaks 101, 102, 103 that are configured to break down the edible input material into smaller particles. The breaks 101, 102, and 103 are arranged in parallel with one another such that the output of each break 101, 102, and 103 does not feed directly as input into one or another of the other breaks. Instead, the output of each break 101, 102, and 103 is distributed by the aforementioned distribution system 130, which sorts the output of each break 101, 102, and 103 and distributes particles based on particle size back to one or more of the breaks as input for further milling. If some of the sorted particles output from the breaks 101, 102, and 103 meet the size requirements of the product specification, those particles are sorted by the distribution system 130 and sent to a finished product storage 160.

Each break 101, 102, and 103 includes a mill 101a, 102a, and 103a connected to an input hopper 101b, 102b, 103b and input sampler 101c, 102c, and 103c and an output hopper 101d, 102d, and 103d and output sampler 101e, 102e, and 103e. Between the input sampler 101c, 102c, and 103c and the mill 101a, 102a, and 103a is a vibratory feeder 101f, 102f, and 103f that is configured to feed particles into the mill using vibration. The input hoppers 101b, 102b, 103b and output hoppers 101d, 102d, and 103d may have sensors (not shown) to measure hopper mass and hopper fill level. Such hopper sensors are part of the measurement system 120 that is connected to the control system 140.

The input samplers 101c, 102c, and 103c and the output samplers 101e, 102e, and 103e are part of the measurement system 120 and are connected to one or more inline measurement devices 121, 122 that are configured to measure properties of the particles sampled at the inlet and output samplers. Also, a sampler 161 is connected to the inlet of the product storage 160. The input samplers 101c, 102c, and 103c, the output samplers 101e, 102e, and 103e, and the sampler 161 are configured to send sample material to the inline measurement devices 121, 122 upon receipt of a sample request issued by the control system 140. Such sample request may be periodic. In the embodiment shown in FIG. 1, one inline measurement device 121 (e.g., a CAMSIZER X2, a product of Microtrac Retsch GmbH) is configured to measures particle size distribution of sampled material, and another inline measurement device 122 (e.g., a DOSCHER, a product of DOSCHER Microwave Systems GmbH) is configured to measure the bulk density moisture of the sampled material. The particle size and bulk density moisture measurements are used as inputs to the control system 140.

Each mill 101a, 102a, and 103a includes a set of milling rollers 105a, 105b, 105c configured to break down material input to the mill. The rollers 105a, 105b, 105c are spaced from one another by an adjustable gap. When the gap is smaller than the particles being fed to the mill, the particles fed into the mills 101a, 102a, and 103a are broken by the rollers 105a, 105b, 105c and then discharged downstream. A ratio of particle size upstream and downstream of each mill is called a primary to cut ratio. The larger the primary to cut ratio is, the less material is removed from the particles input to the mill.

A gap sensor (not shown) of the measurement system 120 is provided to measure the gap between the rollers of each set of 105a, 105b, 105c. The gap sensor is connected to the control system 140. The gap between the rollers 105a, 105b, 105c can be automatically adjusted during milling by the aforementioned control system 140, as described in greater detail herein below. For example, if the average size of the particles in the distribution measured at the output sampler 101e, 102e, and 103e is determined to be larger than desired, the control system 140 can adjust (decrease) the roller gap to reduce the particle size output by the mill. In addition to the roller gap, a speed ratio between the rollers of a mill 101a, 102a, 103a can be measured by the measurement system 120 and adjusted and controlled by the control system 140. Specifically, a speed sensor (not shown) of the measurement system 120 can be used to measure the speed of each roller, and, in turn, used to determine the roller speed ratio between the rollers of each mill 101a, 102a, 103a. Such speed sensors of the measurement system 120 are connected to the control system 140. The rollers are motorized so that their speed can be controlled by the control system 140 based in part on the roller speed ratio.

As noted above, the distribution system 130 distributes material between the breaks 101, 102, 103 and product storage 160. The distribution system 130 includes a plurality of blower/eductors 131, 132, 133 connected downstream of the output sampler 101e, 102e, and 103e of each of the breaks 101, 102, 103, and a particle sorter or sifter 134. The blower/eductors 131, 132, 133 are configured to move material output from each break 101, 102, 103 to the sorter or sifter 134. Also, the distribution system 130 includes blower/eductors 135, 136, 137 that move sorted material to the input hoppers of breaks 102 and 103 and the product storage 160 based on particle size. The blower speed of the blowers connected to the sorter or sifter 134 can be measured by the measurement system 120 and adjusted by the control system 140 to control the flow rate of material through the system 100 and the levels of the input hoppers 101b, 102,b, 103b and output hoppers 101d, 102d, 103d.

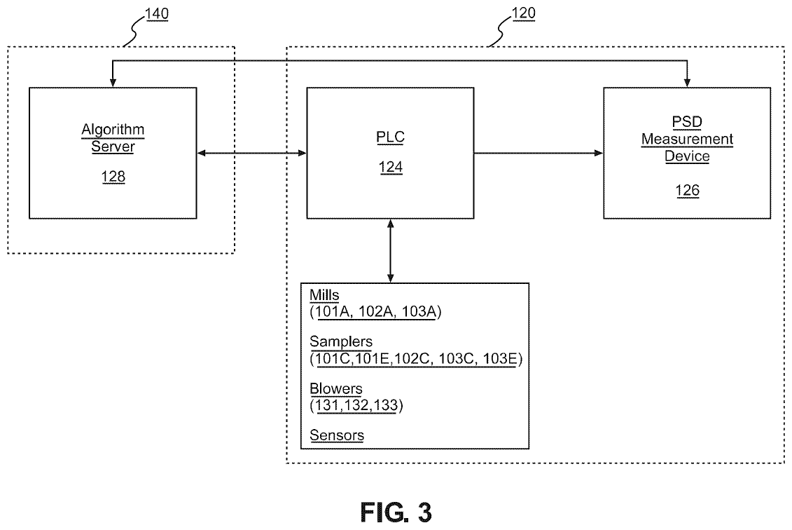

The measurement system 120 is configured to generate measurement data for use by the control system 140. A schematic architecture of the control system 140 and its interfaces to the measurement system 120 is shown in FIG. 3. A programmable logic controller (PLC) 124 is shown communicatively coupled to a particle size distribution (PSD) measurement device 126 via, e.g., an RS232 interface. The PLC 124 is configured to send a measurement request for the PSD measurement device 126 to generate and send PSD measurement data to an algorithm server 128 (e.g., an algorithm server executing a control and/or learning algorithm) that is communicatively coupled to both the PSD measurement device 126 and the PLC 124. Alternatively, the PLC 124 may be configured to receive the PSD data output from the PSD measurement device 126 and then output the data to the algorithm server 128.

In addition, the PLC 124 is bidirectionally communicatively coupled to other elements of the measurement system 120. For example, the PLC 124 is connected to the gap sensors and gap size controls, roller speed sensors and roller speed controls, to the sampler controls, to the blower speed sensor and blower speed controls, and to the hopper mass sensors and hopper level sensors. The PLC 124 receives the outputs of the measurement system 120 and sends them to the control system 140, which processes measurements using an algorithm and the in-turn outputs control parameters (e.g., roller speed and gap settings, sampling requests, and blower speed settings) to the milling system 100 via the PLC 124.

The aforementioned control system 140 is a continuously self-learning control system that includes a processor and a memory. The processor is configured to perform operations, based on a continuously self-learning algorithm, that include receiving and processing the measurement data to dynamically control in real-time the milling rollers 105a, 105b, 105c of each of the breaks 101, 102, 103 to mill the edible input material into the edible product configuration while maximizing a ratio of particle sizes upstream and downstream of each mill 101a, 102a, 103a.

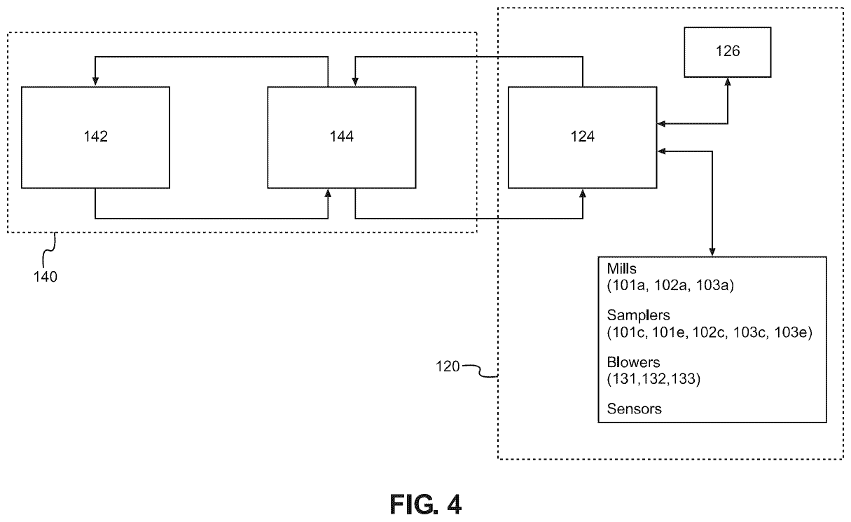

FIG. 4 shows further details of the control system 140 shown in FIG. 3. As shown in FIG. 4, the control system 140 may include a learning module 142 and an edge computer 144 (including a processor and a memory) communicatively coupled together and to the PLC 124 of FIG. 3. In FIG. 4, the PLC 124 is configured to send PSD measurements to the edge computer 144 along with the other measurements discussed above with respect to FIG. 3. In response, the edge computer 144 outputs operational settings, such as gap and roller speed ratio settings, to the PLC 124.

The output operational settings, such as gap and roller speed ratio settings, are determined by the edge computer 144 using an algorithm or model executed based on the measurement data from the PLC 124. The algorithm in use at any time is updatable by the learning module 142. The edge computer 144 sends measurement data from the PLC 124 to the learning module 142, which, in turn, uses machine learning to generate an updated algorithm or operational model of the milling system 100 that is output and sent to the edge computer 144 to update the algorithm used to determine the operational settings used to control the milling system 100.

The edge computer 144 has a model controller (e.g., CPU having a memory) that controls the operation and updating of the operational model used by the edge computer 144 and outputs operational settings (roller gap and roller speed ratio settings) to the PLC 124. The PLC 124 then adjusts the operational settings of the devices it controls, such as the rollers of the mills via roller speed and roller gap.

The learning module 142 includes a historical data storage that stores data received from the edge computer 144. The stored historical data is used as input to the machine learning model. Also, the learning module 142 stores previously used models for later comparison. The stored models can correspond to specific raw material and product configuration combinations. Thus, for example, an operational model may be stored for a specific type and grade of pepper and for “coarse pepper” product configuration, whereas a separate model may be stored for the same type and grade of pepper but for “fine ground pepper,” since the operational parameters needed for both combinations will be different.

The PLC 124 is also communicatively coupled to a human machine interface (HMI), which is usable by an operator to input a selection identifying the edible input material to be milled and the edible product configuration to be output by the milling system 100.

The model controller of the edge computer 144 is configured to trigger the learning module 142 to generate a new model if the model controller determines that the model being used no longer adequately controls the milling process, e.g., if the model controller determines from the PLC data a larger deviation between predicted measurements and actual data or if an operator requests the milling system 100 to mill a new product configuration for which the system has not previously stored a control model.

The control system 140 is configured, in response to receiving the operator's selection via the HMI, to initialize operational settings of the milling system 100. For example, if a model has been previously stored corresponding to the operator's selection, the model controller obtains the stored model in the model storage through the learning module 142. If a model has not previously been stored corresponding to the operator's selection, then the model controller can trigger the learning module 142 to begin learning a new operational model corresponding to the operator's selection. In the latter scenario, the learning module 142 will initially provide the model controller with an initial model to begin operating the milling system 100 in a learning mode, as will be described in greater detail herein below.

Once an operational model is in use by the model controller, the edge computer 144 continuously controls the milling system 100 based on the control model and the measurement data provided to the control system 140 from the measurement system 120. Specifically, the control system 140 is configured to operate and control the breaks 101, 102, 103 to mill the edible input material based on the initialized operational settings determined by the control model, and to continuously update those operational settings and the control model based on at least the continuously self-learning algorithm employed in the learning module 142, the measurement data, and the target output specification.

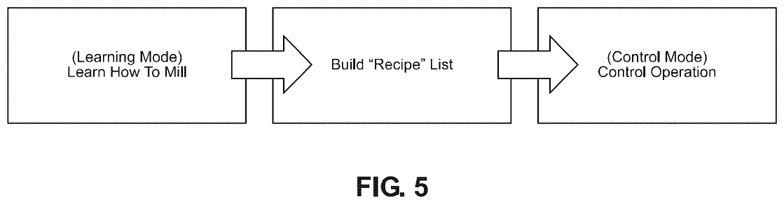

Further details of the control system 140 and its learning and control methods will now be described with reference to FIGS. 5-7. As shown in FIG. 5, there are two distinct modes of operation of the milling system 100: learning mode; and control mode. Although the learning mode and control modes are distinct, they can occur in parallel. In the learning mode, the control system 140 learns how to mill the selected edible input material into the product configuration. Specifically, the control system 140 uses a learning algorithm to control various milling variables, such as roller gap and roller speed ratio, to maximize the production of edible material meeting the target product specifications of the desired product configuration. Once the operational parameters corresponding to optimal production are obtained, those parameters are stored as an operational model that can be used to initialize the milling system 100 to operate in control mode for milling the corresponding combination of edible input material and product configuration.

The learning mode can be run multiple times for multiple combinations of edible input material and desired product configuration to generate corresponding control models that can be stored in the learning module 142 for future retrieval. Once a control model is learned, it can be retrieved by the model controller and used to initialize and operate the milling system 100 in control mode. In control mode, the control system 140 uses a control algorithm to repeatedly measure particle size distributions at various points in the system according to a predefined script to ensure that target particle size distributions are met.

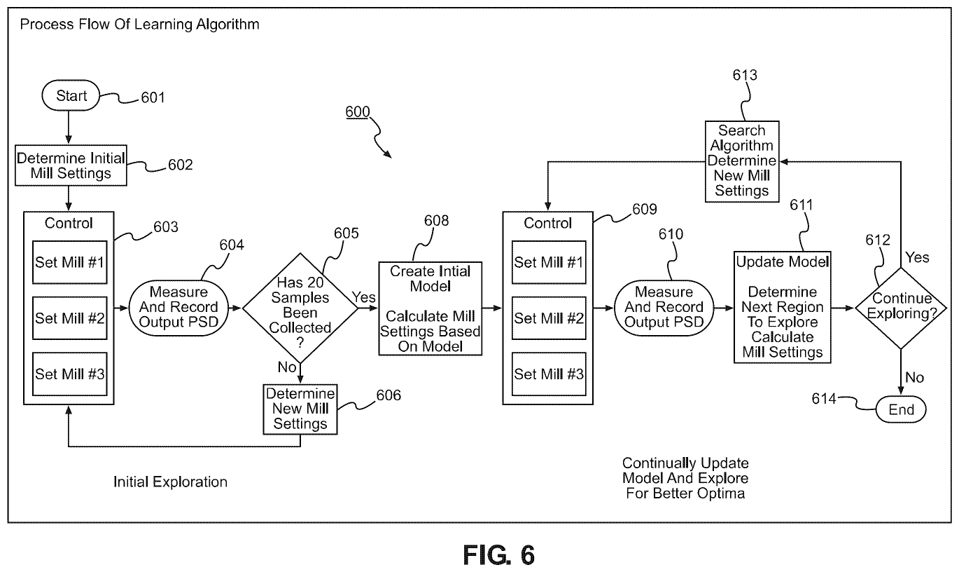

FIG. 6 illustrates a workflow of the learning algorithm. At the beginning of the workflow at 601, the learning process is triggered by the model controller. Then, initial mill settings are determined to begin the learning process. The initial mill settings include roller speed ratio and roller gap, which can be based on parameters of the edible input product (such as bulk density and moisture) and the desired product configuration. At 603 the model controller outputs the determined initial mill settings to the mills 101a, 102a, 103a using the PLC 124. At 604 the mills 101a, 102a, 103a are operated to mill samples of the edible input material while the measurement system 120 obtains measurement data which is stored in the historical data storage of the learning module 142. At 605 it is determined if a certain number (e.g., twenty samples in FIG. 6) of samples of milled product have been collected and measured. If “NO” at 605, the algorithm determines and suggests updated operational settings for the mills 101a, 102a, 103a which are updated at 603, upon which the mills 101a, 102a, 103a operate again on the edible input material while measurement data is obtained and stored at 604. Workflow steps 603-606 are repeated until the certain number of samples of milled product have been collected (“YES” at 605). As a result of changing the mill settings while collecting data, the algorithm explores the milling variables (e.g., roller gap and roller speed ratio) that impact the particle size distributions at various points in the milling system 100. Once the certain number of samples have been collected, at 608 the learning algorithm creates an initial model of the milling system 100 from the measurement data stored in the historical data storage. The initial model attempts to set the milling system 100 with operational settings that will maximize yield of the product configuration meeting the product specification.

Once the initial operational model of the milling system 100 is created for use by the model controller, the initial operational model can be repeatedly updated to optimize the model. Again, the updating of the initial model can take place in parallel with the control mode of the milling system 100. The updating of the initial model begins at 609 where the mills are set based on the initial control model created at 608. At 610 measurement data is obtained while the milling system 100 is running using the mill settings set at 609. At 611 the initial model created at 608 is updated based upon exploring the effect of changing process variables on particle size distribution. At 612 it is determined whether or not to continue exploring for better optima. If “Yes” at 612, a search algorithm is used to determine new operational settings for the mills 101a, 102a, 103a at 613. If “No” at 612, the learning algorithm ends at 614.

The learning algorithm workflow provides the ability to build the recipe list (FIG. 5) for future milling operations as discussed above. The algorithm exploration provides the ability to find the best milling conditions for a given combination of edible input material and product configuration. Thus, over time the learning algorithm will be used to build the recipe list for milling operations for various combinations of edible input material and product configuration. The recipe list will contain the best known milling conditions and operational settings to convert an edible input material (i.e., raw material) in a desired product configuration. In embodiments, the recipe list will contain the following parameters: edible input material (which may be described by origin and type); mill settings (e.g., roller gap and roller speed ratio); flow settings (e.g., blower settings); roller configuration (specifying the specific roller that is used on a respective mill); and sifter configuration (specifying the configuration of the sifter box).

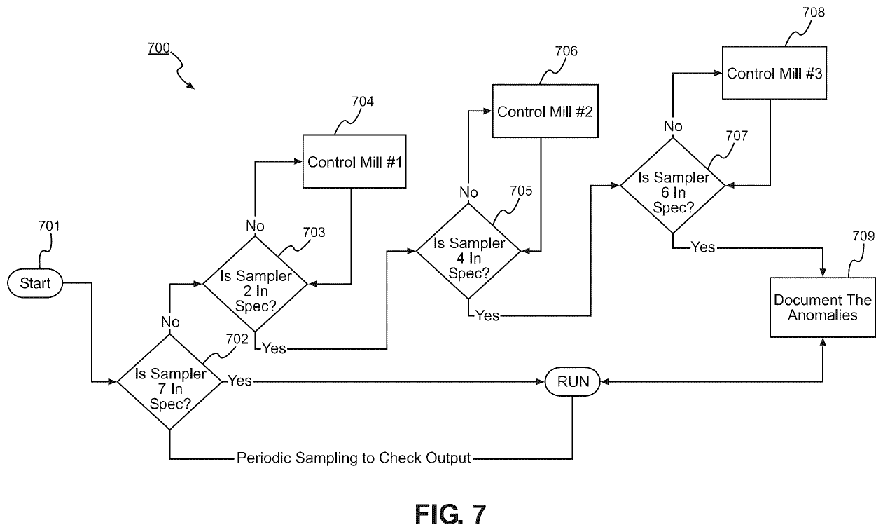

The control algorithm is used to run the milling system 100 in control mode (i.e., “normal operation”). The control algorithm is a supervisory algorithm that measures the output of the system (i.e., the material in the product storage) and checks if the output is within acceptable tolerance of product specifications, i.e., within accepted tolerance of a target PSD as well as conform to user set limits (e.g., for safety). The control algorithm monitors the milling system 100 to ensure optimum milling conditions are maintained and will adjust when they are not. The control algorithm measures the similarity of the measured PSD to the target PSD using a mean square error (MSE). When the MSE is smaller than the prescribed threshold, the system will continue with current settings and no adjustments will be triggered. However, when the MSE is larger than the prescribed threshold, a series of interventions will be triggered as shown in FIG. 7.

FIG. 7 shows a control logic workflow 700 for monitoring and adjusting mill conditions based on PSD measurements. At 701 the monitoring process begins. At 702 it is determined if the PSD of material sampled at sampler 161 (which samples the material entering product storage 160) is within the target specification for the product configuration. If “Yes” at 702, then the algorithm repeats checking at 702. If “No” at 702, then at 703 then it is determined if the PSD of material sampled at sampler 101e (corresponding to the output of mill 101a of break 101) is within a target specification. If “Yes” at 703, then no control action is taken on mill 101a and checking moves to 705. However, if “No” at 703, then the corrective action is triggered at 704 to change mill settings of mill 101a. At 705 it is determined if the PSD of material sampled at sampler 102e (corresponding to the output of mill 102a of break 102) is within a target specification. If “Yes” at 705, then no control action is taken on mill 102a and checking moves to 706. If “No” at 705, then corrective action is triggered at 706 to change mill settings of mill 102a. At 707 it is determined if the PSD of material sampled at sampler 103e (corresponding to the output of mill 103a of break 103) is within a target specification. If “Yes” at 707, then no control action is taken on mill 103a and checking moves to 709 whereupon any anomalies are documented and the checking returns to 702. If “No” at 707, then corrective action is triggered at 708 to change mill settings of mill 103a. It is noted that the monitoring and control logic described above and shown in FIG. 7 is merely exemplary and is just one option of many that can be implemented.

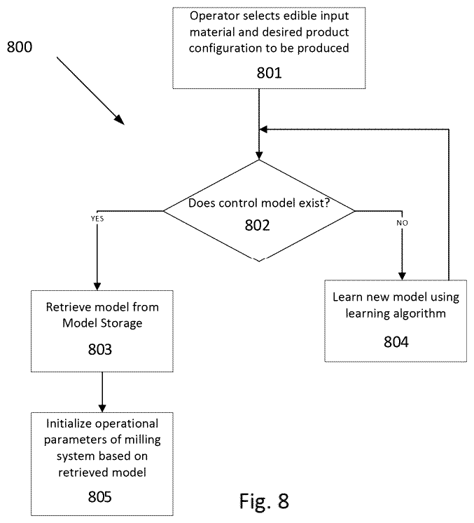

An example process of operating the milling system 100 will now be described with reference to the workflow 800 shown in FIG. 8. At 801, an operator uses the HMI to input or select the edible input material to be milled and a product configuration to be produced. At 802 the model controller will determine whether or not a previously stored control model exists for the combination of input material and product configuration entered by the operator. If “No” at 802, the model controller triggers the learning module at 803 to learn a new operational model and the system enters the learning mode while the control mode runs in parallel to control the milling system 100. Once an operational model is learned at 803, the process returns to 802. If “Yes” at 802, the learning module 142 will retrieve the store control model at 803 and initialize the model controller with that stored control model. At 805, the model controller will cause the PLC 124 to send control signals to the milling system 100 to initialize the milling system 100 based on the stored operational parameters. Specifically, the algorithm server 128 will provide the following: mill set conditions (roller gap and roller speed ratio, set by the PLC 124); sifter set up requirements (to be set up by the operator); roller configuration (to be set up by the operator); and mill flow rates (blower speeds, set by the PLC 124). Once all of the operational settings have been set, the operator can start the milling process and the milling system 100 will operate in control mode with the supervisory monitoring and control algorithm running to ensure the optimum milling conditions are maintained and adjust when they are not.

When the breaks 101, 102, 103 operate in control mode the control algorithm operates so as to maximize the primary to cut ratio of each mill 101a, 102a, 103a while trying to obtain a particle size distribution of finished product entering the product storage within a range of the product specification of the product configuration to be produced. The first mill 101a is configured to mill the edible input material into particles having sizes defining a first particle size distribution that includes a first range of particle sizes and a second range of particle sizes different from the first range of particle sizes. The first range of particle sizes meet the product specifications of the product configuration and are sorted and sent to product storage and not routed to either the second break 102 or the third break 103. The second 102 and the third 103 breaks are configured to mill the particles output from the first break 101 that are in the second range of particle sizes that were not sent to product storage. In embodiments, particles having sizes in a first sub-range of the second range are routed to the second break 102 while particles having sizes in a second sub-range of the second range are routed to the third break 103. For example, in one embodiment, the first sub-range has larger particle sizes than the second sub-range. Thus, in embodiments, the average particle size in the particle size distribution on the output of the first break 101 will be larger than the average particle size in the particle size distribution of the output of the second break 102, which will be larger than the average particle size in the particle size distribution of the output of the third break 103. By maximizing the ratio of the particle sizes before and after each mill 101a, 102a, 103a, the system attempts to minimize the amount of fine particles that cannot be used as finished product.

In the event of severance of communication within the system, the PLC 124 will continue using its last used operating parameters to operate the milling system 100. Safety is not compromised in this scenario because safety systems of the milling system 100 are controlled by the PLC 124.

It is noted that the foregoing examples have been provided merely for the purpose of explanation and are in no way to be construed as limiting of the present disclosure. While the present disclosure has been described with reference to exemplary embodiments, it is understood that the words which have been used herein are words of description and illustration, rather than words of limitation. Changes may be made, within the purview of the appended claims, as presently stated and as amended, without departing from the scope and spirit of the present disclosure in its aspects. Although the present disclosure has been described herein with reference to particular structures, materials and embodiments, the present disclosure is not intended to be limited to the particulars disclosed herein; rather, the present disclosure extends to all functionally equivalent structures, methods and uses, such as are within the scope of the appended claims.

What is claimed is:

1. A milling system for milling an edible input material, which includes a spice, an herb, a seed, or a combination thereof, into an edible product configuration meeting a target output specification, the system comprising:
a first mill including a first set of milling rollers configured to mill the edible input material into particles having sizes defining a first particle size distribution, the particle size distribution including a first range of particle sizes and a second range of particle sizes different from the first range of particle sizes;
a second mill including a second set of milling rollers configured to mill particles of the edible input material having particle sizes only in the second range of particle sizes;
a measurement system configured to generate measurement data, the measurement system including:
at least one inline sensor configured to measure attributes of the edible input material upstream and downstream of the first and second mills, the attributes of the edible input material including at least one of particle size, moisture bulk density, and flow rate; and
at least one sensor to measure attributes of the first and second sets of milling rollers; and
a continuously self-learning control system, including a processor and a memory, the processor being configured to perform operations, based on a continuously self-learning algorithm, the operations including:
receiving and processing the measurement data to dynamically control in real-time the first and second sets of milling rollers to mill the edible input material into the edible product configuration while maximizing a first ratio of particle size upstream of the first mill to particle size downstream of the first mill and maximizing a second ratio of particle size upstream of the second mill to particle size downstream of the second mill; and
receiving a selection identifying the edible input material to be milled and the edible product configuration to be output by the milling system, the edible product configuration being associated with the target output specification and, wherein
in response to receiving the selection, the control system is configured to initialize operational settings of the first and second sets of milling rollers based on an initial control model of the milling system associated with the selection and operate and control the first and second mills to mill the edible input material based on the initial operational settings, and continuously update the control model and operational settings based on at least the continuously self-learning algorithm, the measurement data, and the target output specification.

2. The milling system according to claim 1, wherein:
the control system is configured to store a control model corresponding to the edible product configuration and the edible input material, and the control system is configured to determine whether a control model is stored corresponding to the selection of the edible input material and the edible product configuration,
wherein if the control system determines that an control model is stored corresponding to the selection of the edible input material and the edible product configuration, the control system is configured to retrieve the stored control model as the initial control model, and if the control system determines that an control model is not stored corresponding to the selection of the edible input material and the edible product configuration, the control system is configured to operate the milling system in a learning mode to generate the initial control model,
wherein in the learning mode the milling system is operated and controlled to generate measurement data while producing a plurality of samples of milled edible input material, wherein the control system is configured to process the measurement data associated with producing the plurality of samples to generate the initial control model.

3. The milling system according to claim 1, wherein:
the at least one sensor to measure attributes of the first and second milling rollers is configured to measure at least one of a gap and a speed ratio between milling rollers of the first and second sets of milling rollers, and
the control system, in response to the measurement data, is configured to adjust at least one of the gap and speed ratio between milling rollers of the first and second sets of milling rollers, wherein the milling rollers of the first mill are configured to be adjusted independently of the milling rollers of the second mill.

4. The milling system according to claim 1, further comprising:
a distribution system configured to collect, sort, and distribute particles of edible input material between the first and second mills and a finished product storage based on the measurement data, wherein the distribution system includes a sorter configured to sort particles by particle size and a blower configured to distribute particles to the first and second mills and the finished product storage by particle size.

5. The milling system according to claim 4, wherein:
the control system is configured to adjust at least one of the first and second mills in response to a comparison of attributes of particles of edible input material entering the finished product storage and the target output specification,
wherein in a first configuration where a difference in attributes between the edible input material entering the finished product storage and the target output specification are greater than a threshold, the control system is configured to adjust at least one operational setting of at least one of the first and second mills based on the control model, and
in a second configuration where the difference in attributes between edible input material entering the finished product storage and the target output specification are less than the threshold, the control system is configured to maintain the operational settings of the first and second mills.

6. The milling system according to claim 4, wherein:
the measurement system includes an inline bulk density measurement device that is configured to receive and measure bulk density of samples of edible input material upstream and downstream of the first and second mills and upstream of the finished product storage.

7. The milling system according to claim 1, wherein:
the second range of particle sizes includes particle sizes larger than particle sizes in the first range of particle sizes.

8. The milling system according to claim 7, further comprising:
a third mill configured to mill particles of edible input material,
wherein the second mill is configured to mill particles of edible input material into particles having sizes defining a second particle size distribution, the second particle size distribution including particle sizes in the first range of particle sizes and a third range of particle sizes different from the first range of particle sizes, and
wherein the second mill is configured to mill particles having particle sizes in a first sub-range of the third range of particle sizes and the third mill is configured to mill particles having particle sizes in a second sub-range of the third range of particle sizes different from the first sub-range.

9. A milling method for a milling system adapted for milling an edible input material, which includes a spice, an herb, a seed, or a combination thereof, into an edible product configuration meeting a target output specification, the method comprising:
a first milling by a first mill of the milling system, the first mill including a first set of milling rollers for milling the edible input material into particles having sizes defining a first particle size distribution, the particle size distribution including a first range of particle sizes and a second range of particle sizes different from the first range of particle sizes;
a second milling by a second mill of the milling system, the second mill including a second set of milling rollers for milling particles of the edible input material having particle sizes only in the second range of particle sizes;
generating measurement data by:
inline measuring attributes of the edible input material upstream and downstream of the first and second mills, the attributes of the edible input material including at least one of particle size, moisture bulk density, and flow rate; and
measuring attributes of the first and second sets of milling rollers; and
controlling the milling system, by a continuously self-learning control system based on a continuously self-learning algorithm, by performing operations including:
receiving and processing the measurement data to dynamically control in real-time the first and second sets of milling rollers to mill the edible input material into the edible product configuration while maximizing a first ratio of particle size upstream of the first mill to particle size downstream of the first mill and maximizing a second ratio of particle size upstream of the second mill to particle size downstream of the second mill; and
receiving a selection identifying the edible input material to be milled and the edible product configuration to be output by the milling system, the edible product configuration being associated with the target output specification and, wherein
in response to receiving the selection, the controlling includes initializing operational settings of the first and second sets of milling rollers based on an initial control model of the milling system associated with the selection and operating and controlling the first and second mills to mill the edible input material based on the initial operational settings, and continuously updating the control model and operational settings based on at least the continuously self-learning algorithm, the measurement data, and the target output specification.

10. The milling method according to claim 9, further comprising:
determining whether a control model is stored corresponding to the selection of the edible input material and the edible product configuration; and
if it is determined that an control model is stored corresponding to the selection of the edible input material and the edible product configuration, retrieving the stored control model as the initial control model; and
if it is determined that an control model is not stored corresponding to the selection of the edible input material and the edible product configuration, operating the milling system in a learning mode to generate the initial control model,
wherein in the learning mode, the milling system is operated and controlled to generate measurement data while producing a plurality of samples of milled edible input material, and wherein the controlling includes processing the measurement data associated with producing the plurality of samples to generate the initial control model.

11. The milling method according to claim 9, wherein:
the attributes of the first and second milling rollers include at least one of a gap and a speed ratio between milling rollers of the first and second sets of milling rollers, and
the controlling includes, in response to the measurement data, adjusting at least one of the gap and speed ratio between the rollers of the first and second sets of milling rollers, wherein the milling rollers of the first mill are adjusted independently of the milling rollers of the second mill.

12. The milling method according to claim 9, further comprising:
collecting the milled particles of the edible input material,
sorting the collected particles of the edible input material by particle size, and
distributing the sorted particles of the edible input material by particle size between the first and second mills and a finished product storage.

13. The milling system according to claim 12, wherein:
the controlling includes adjusting at least one of the first and second mills in response to a comparison of attributes of particles of edible input material entering the finished product storage and the target output specification,
wherein when a difference in attributes between the edible input material entering the finished product storage and the target output specification are greater than a threshold, controlling includes adjusting at least one operational setting of at least one of the first and second mills based on the control model, and
wherein when the difference in attributes between edible input material entering the finished product storage and the target output specification are less than the threshold, controlling includes maintaining the operational settings of the first and second mills.

14. The measurement method of claim 12, wherein:
the generating measurement data includes measuring bulk density of edible input material sampled upstream and downstream of the first and second mills and upstream of the finished product storage.

15. The milling system according to claim 9, wherein:
the second range of particle sizes includes particle sizes larger than particle sizes in the first range of particle sizes.

16. The milling system according to claim 15, further comprising:
a third milling by a third mill having a third set of milling rollers configured to mill particles of edible input material,
wherein the second milling mills particles of edible input material into particles having sizes defining a second particle size distribution, the second particle size distribution including particle sizes in the first range of particle sizes and a third range of particle sizes different from the first range of particle sizes, and
wherein the second milling mills particles having particle sizes in a first sub-range of the third range of particle sizes and the third milling mills particles having particle sizes in a second sub-range of the third range of particle sizes different from the first sub-range.

17. A control method for continuous self-learning and control of a milling system having a plurality of mills coupled together by a particle distribution system, the mills being configured to mill an edible input material in parallel based at least on particle size into an edible product configuration having an associated target output specification, the control method comprising:
learning an initial control model of the milling system based at least on measured attributes of the edible input material sampled at a plurality of locations in the milling system;
continuously self-learning and updating the initial control model with an optimized control model;
storing the updated control model; and
controlling and regulating the plurality of mills during the learning and updating of the initial control model, wherein
the initial and updated control models of the milling system are used for controlling and regulating the milling system to mill the edible input material into the edible product configuration while maximizing a ratio of particle size of edible input material upstream of each mill to particle size of edible input material downstream of each mill.

18. The control method according to claim 17, wherein the learning includes:
initializing operational parameters of the plurality of mills of the milling system;
controlling and regulating the mills to produce a plurality of samples of milled edible input material while obtaining measured attributes of the edible input material; and
generating the initial control model that relates operational parameters of the milling system and the measured attributes of the edible input material to the target output specification.

19. The control method according to claim 18, wherein the learning includes:
predicting updated operational parameters of the plurality of mills from a comparison of measured attributes of the milled edible input material and the target output specification; and
updating the operational parameters of the mills with the predicted updated operational parameters, wherein the operational parameters are limited by a predetermined range of operational limits.

20. The control method according to claim 19, further comprising:
retrieving a stored control model in response to receiving a selection of an edible input material and an edible target product associated with the stored control model; and
configuring the milling system in accordance with operational parameters associated with the retrieved control model.
